(19) United States
(12) Patent Application Publication
(10) Pub. No.: US 2014/0019836 A1
(43) Pub. Date: Jan. 16, 2014

(54) METHODS FOR HANDLING URLS TO TRIGGER FUNCTIONALITIES

(71) Applicants: Sriram Sampathkumaran, San Diego, CA (US); Aravind Asam, San Diego, CA (US); Dipendu Saha, San Diego, CA (US)

(72) Inventors: Sriram Sampathkumaran, San Diego, CA (US); Aravind Asam, San Diego, CA (US); Dipendu Saha, San Diego, CA (US)

(73) Assignee: SONY CORPORATION, Tokyo (JP)

(21) Appl. No.: 13/547,914

(22) Filed: Jul. 12, 2012

(51) Int. Cl. G06F 17/00

(52) U.S. Cl. 715/205

(57) ABSTRACT

A method of handling Internet links includes providing a link associated with a uniform resource locator (“URL”) including a scheme name that references an application, and a handler-directive that references a functionality to be performed by the application. The link can be provided in an internet browser on a display screen of an electronic device. The method further includes launching the application referenced by the URL in response to a user selecting the URL. The launched application includes a URL handler, which receives the URL and breaks up the URL to separate the handler-directive. The method further includes determining whether the handler-directive is supported in the URL handler. The functionality referenced by the handler-directive is then performed by the application.

### FIELD

This invention relates to hyperlinks, and more specifically, to hyperlinks displayed on Internet-enabled display devices and handling the URLs underlying the hyperlinks.

### BACKGROUND

Electronic devices such as televisions, mobile phones, PDAs, tablet computers, personal computers, DVD Players, and game consoles are equipped with the Internet TV capability, where the electronic device serves as a gateway delivering select Internet content and a variety of on-demand entertainment straight to the device. Examples of Internet TV systems include Sony's Android based TV and Blue ray players which can be used with devices such as Sony Bravia TVs (BTVs) to provide users with access to online television programming via the Internet.

Browsers in Internet TV systems typically operate via user clicks on on-screen icons/hyperlinks and uniform resource locators (URLs). The URLs referenced by hyperlinks in a web browser on a user's screen can be sent to various applications to initiate various functionalities. As more and more features and functionalities are added within an application, it is important that scalability issues (especially after sale since broadcasting software updates are expensive) are handled wisely, i.e., that the application is capable of handling the growing number of features and internet links, and can be expanded to adequately accommodate such growth. One solution could be to let the application recognize URLs having a scheme that can take different formats which will invoke appropriate functionality within the application. Such a solution is likely to require constant labor and resources and is not cost-effective.

Accordingly, what is needed is a method of uniform URL handling that can be implemented within an application to invoke multiple functionalities.

### SUMMARY

The present invention satisfies this need. In an embodiment, a method of handling Internet links comprises: providing a link associated with a uniform resource locator (“URL”) in an Internet browser on a display of an electronic device, the link including a scheme name that references an application, and a handler-directive that references a functionality to be performed by the application; launching the application referenced by the URL in response to a user selecting the URL, the application including a URL handler; receiving the URL in the URL handler of the application, the URL handler breaking up the URL to separate at least the handler-directive; determining whether the handler-directive is supported in the URL handler; and performing, via the application, the functionality referenced by the handler-directive.

Providing a URL can comprise providing a URL including a scheme name comprising a name of the application.

The method can also comprise returning an error message to the user in response to a determination that the handler-directive is not supported in the URL handler.

In one approach, determining whether the handler-directive is supported in the URL handler can further comprise specifying a plurality of handler-directives supported in the URL handler. The method can further comprise matching the handler-directive separated from the URL to one of the plurality of handler-directives supported in the URL handler.

In another embodiment, a method of handling Internet links comprises: providing at least one link in an Internet browser on a display of an electronic device, the at least one link being associated with a uniform resource locator (“URL”) that includes a scheme name that references an application; permitting a user to select the at least one link; launching the application referenced by the URL in response to the user selecting the at least one link; sending the URL associated with the at least one link to a URL handler of the launched application, the URL including a handler-directive referencing a functionality associated with the launched application; breaking up the URL in the URL handler to separate the handler-directive; and determining whether the separated handler-directive is supported in the URL handler.

The method can further comprise launching the functionality referenced in the handler-directive via the launched application in response to a determination that the separated handler-directive is supported in the URL handler. The method can also comprise returning an error message to the user in response to a determination that the separated handler-directive is not supported in the URL handler.

Sending the URL can include sending the URL including a scheme name comprising a name of the application. Breaking up the URL can include breaking up the URL to separate at least the scheme name and the handler-directive.

In one approach, determining whether the separated handler-directive is supported in the URL handler further comprises storing associating with the URL handler a plurality of handler-directives supportable in the URL handler. The method can further comprise determining that the separated handler-directive matches one of the handler-directives supportable in the URL handler.

Providing at least one link in an Internet browser on a display of an electronic device can include providing an electronic device selected from a group consisting of televisions, personal computers, tablet computers, mobile phones, personal digital assistants, DVD players and video game consoles.

Permitting the user to select the at least one link includes providing a user with at least one of a keyboard, a mouse, a roller wheel, or a remote control. Launching the application referenced by the URL can include launching the application within an Android operating system.

The methods described in the present application provide numerous advantages over the presently used systems and methods, which will be appreciated by those of ordinary skill in the art with reference to the following drawings, detailed description, and claims.

### BRIEF DESCRIPTION OF THE DRAWINGS

FIG. 1 is a sample screen shot of a display screen of an Internet-enabled electronic device;

FIG. 2 is a schematic diagram of the display screen of FIG. 1 displaying a link and an enlarged view of a sample application that receives a URL associated with the link;

FIG. 3 is a schematic diagram showing components of a hyperlink according to one embodiment of the present invention; and

FIG. 4 is a flow chart diagram illustrating a method according to a preferred embodiment of the invention.

### DETAILED DESCRIPTION

Reference will now be made in detail to the present preferred embodiments of the invention, examples of which are illustrated in the accompanying drawings.

Generally, users can navigate Internet Browsers on Internet-TV platforms such as Android-based GOOGLE TV. Users can select hyperlinks displayed on a screen to go from web page to web page, and to invoke various applications and functionalities. The URLs associated with the hyperlinks are formatted to include a scheme name referencing a target application and a handler-directive referencing a functionality to be performed by the application that can be parsed by a URL Handler of an application launched in response to the user's selection of a hyperlink. If the handler-directive is supported in the URL Handler, the URL Handler reads the rest of the URL and executes the URL as programmed. If the handler-directive is determined not to be supported in the URL Handler, the URL Handler does not read the rest of the URL and returns an error message to the user.

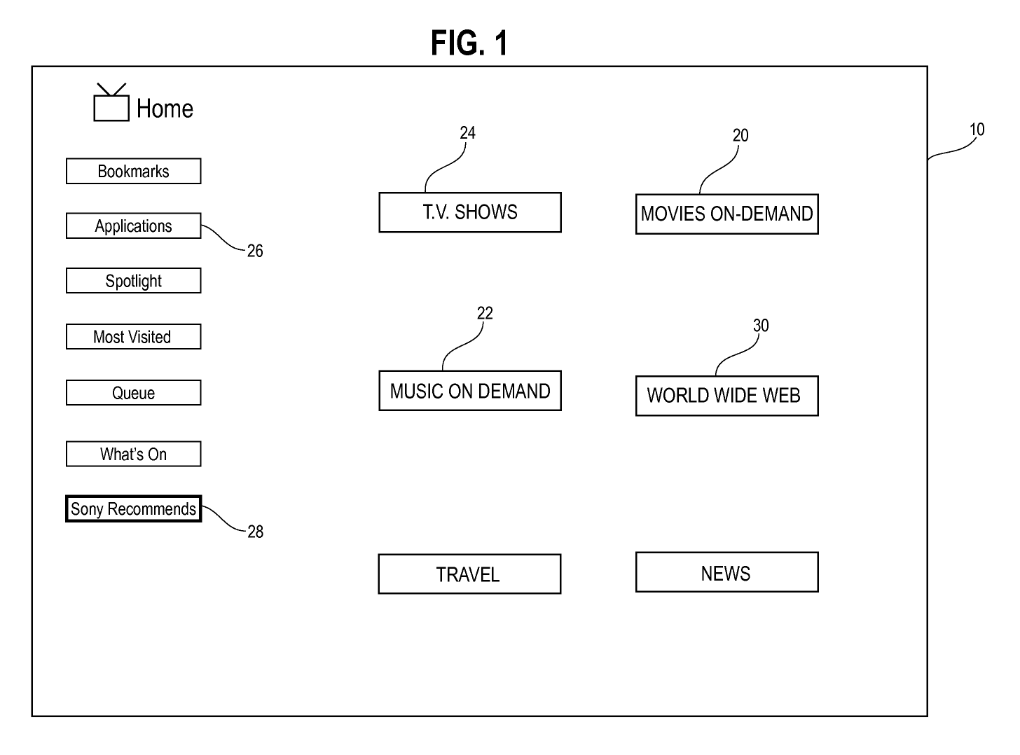

Internet television is becoming increasingly popular because it allows users to choose media content they want to watch from an archive of content or from a channel directory. One way of viewing Internet television is streaming the content directly to a media player and another way is downloading the media to the user's device such as a computer or a set-top-box. One TV platform that allows users to browse, stream, and download media content is an Android-based Google TV platform illustrated in FIG. 1 on a display screen 10 of an electronic device such as a television, tablet computer, personal computer, smart phone, or personal digital assistant (PDA). It is to be appreciated that while an Android-based television platform is shown in FIG. 1, the principles of the present invention could be used with any other television platform, including platforms based on Microsoft Windows and Apple's iOS.

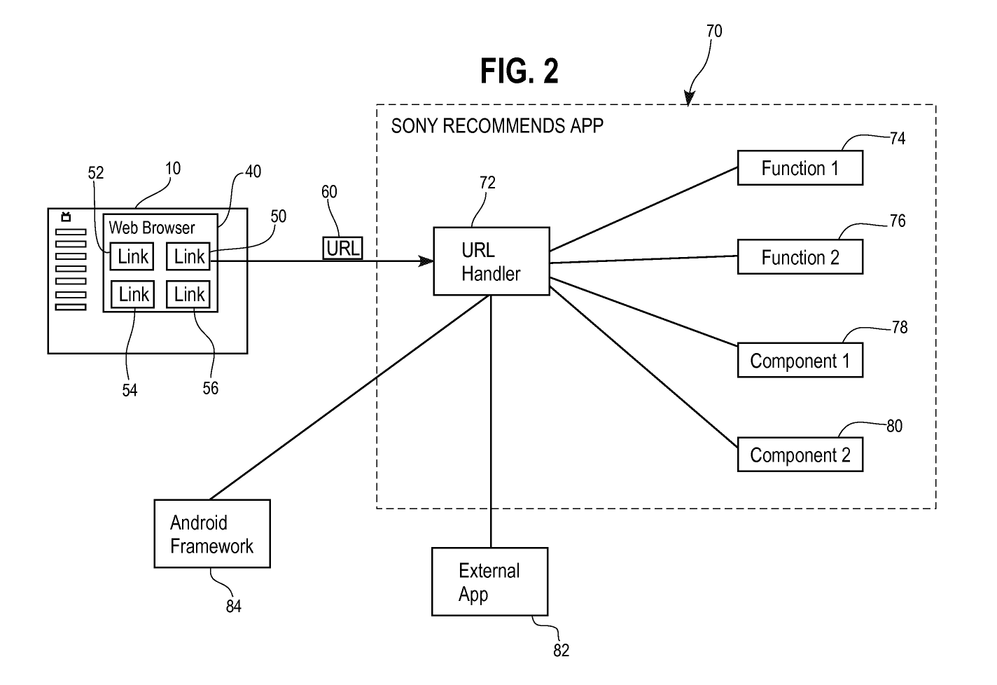

With reference to FIG. 1, an exemplary Google TV home screen includes various clickable icons that can be selected by a user to enjoy various different functionalities that are available to the user from the home screen. For example, a user can click on home screen icons such as “Movies-On-Demand” 20, “Music-on-Demand” 22, “TV Shows” 24, or the like to launch various services. In addition, the user can select an icon such as “Applications” 26 to enjoy one of the many available applications such as online games, or an icon such as “Sony Recommends” 28 to launch the “Sony Recommends App” 70, shown in FIG. 2, which can assist the user with selecting content that would be of interest. Another icon the user can click on is “World Wide Web” 20, the clicking of which would launch an Internet Web Browser, for example, Google Chrome, or any other supported browser.

With reference to FIG. 2, when the display screen 10 of an electronic device displays an Internet Web Browser 40, the user can be presented with a web page including a variety of hyperlinks 50, 52, 54, and 56 that can link the user to additional content. Each of the hyperlinks 50, 52, 54, and 56 can have an underlying link in the form of a Uniform Resource Locator (URL) that can reference a resource such as an Internet address to be fetched or an application to be run. For example, the hyperlink 50 can link the user to the Sony Recommends App 70, the hyperlink 52 can link the user to another web page, the hyperlink 54 can link the user to an online video, and the hyperlink 56 can link the user to an online game.

With continuing reference to FIG. 2, when the user selects the hyperlink 50, for example, by selecting it with a remote control, a keyboard, or a mouse, the URL 60 underlying the hyperlink 50 can be sent to the Sony Recommends App 70, which is the application referenced by the URL 60. It will be appreciated that while the Sony Recommends App 70 has been shown as an example of an application that can be launched in response to the user clicking on a hyperlink in a web browser, any other application or service available in an Internet-TV platform can be launched.

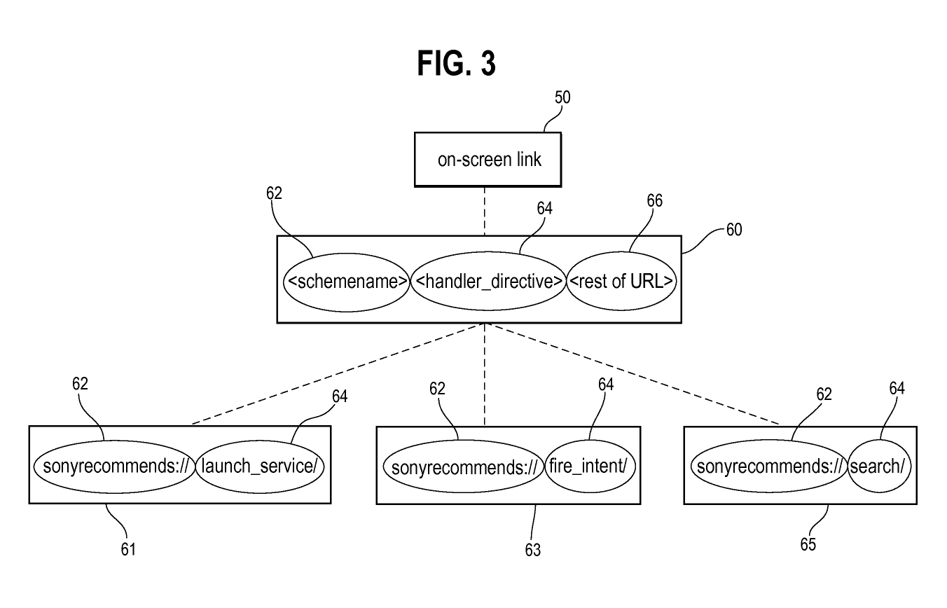

The Sony Recommends App 70 includes a URL Handler 72. The URL Handler 72 can be a subroutine that is programmed to receive the URL 60 and break up the URL into its subcomponents, which are shown in more detail and discussed below in reference to FIG. 3. Upon breaking up the URL 60, the URL Handler 72 can determine to launch Functions 74, 76 and/or Components 78, 80 internal to the Sony Recommends App 70, one or more External Apps 82, or another service in the Android Framework 84, as discussed in more detail below.

Referring to FIG. 3, the exemplary URL 60 is described in more detail. As referenced above, an on-screen icon or link such as the hyperlink 50 has an underlying URL 60 that can reference a resource and/or launch a component or an application. The URL 60 includes three main parts, a scheme name 62, a handler directive 64, and rest of URL 66. In the URL 60, the scheme name 62 “sonyrecommends://” references the resource (e.g., Sony Recommends App 70) to be launched when the hyperlink 50 is selected by the user. The scheme name 62 can alternatively be used to launch any other application or service compatible with an Internet-TV platform. For example, the scheme name 62 of the URL 60 can be “sonybiv://” to launch a service such as Sony's Bravia Internet Video (BIV), which is compatible with the Android TV-platform and browsers. The URL 60 is advantageously unlike conventional URLs at least in that the scheme name 62 of the URL 60, instead of including universally recognizable scheme names such as http:// or https://, includes a scheme name that specifically references a target application and can specifically reference a target application on a specific device. A similar scheme name could work on a non-Android platform (e.g., Windows, iOS) capable of launching an application by sending the URL 60 to an application when a user clicks on the URL 60 in a browser.

With continuing reference to FIG. 3, following the scheme name 62, the URL 60 includes a handler-directive 64. The handler-directive 64 is HTML code that references a functionality referenced by the URL 60. Three exemplary URLs 61, 63, and 65 having an identical scheme name 62 that references the Sony Recommends App 70, but different handler-directives 64 are shown in FIG. 3. The URL 61 includes the handler-directive 64 “launch_service/” which, if supported by the URL Handler 72, serves as an instruction to the Sony Recommends App 70 to launch a service available through the Sony Recommends App 70. The URL 63 includes the handler-directive 64 “fire_intent/” which, if supported by the URL Handler 72, serves as an instruction to the Sony Recommends App 70 to run a functionality available through the Sony Recommends App 70. The URL 65 includes the handler-directive 64 “search/” which, if supported by the URL Handler 72, serves as an instruction to the Sony Recommends App 70 to perform a search for content of interest to the user. The URL 60 is advantageously unlike conventional URLs at least in that handler-directives 64 permit the URL 60 to be formatted to invoke multiple different functionalities of a specific application referenced by the scheme name 62 of the URL 60.

The rest of URL 66, which would follow the handler-directive 64 in each of the URLs 61, 63, and 65, would reference the service to be launched in response to the “launch-service/” handler-directive 64 of the URL 61; the functionality to be run in response to the “fire_intent/” handler-directive 64 of the URL 63, or the search to be performed in response to the “search/” handler-directive 64 of the URL 65. For example, if the URL link 65 were to read “sonyrecommends://search/?keyword=music_unlimited,” based on the scheme name “sonyreommends://,” the Sony Recommends App 70, based on the handler-directive 64 “search/,” would perform a search for the keywords “music unlimited,” based on the rest of URL 66 “?keyword=music unlimited,” returning to the user search results pertaining to Sony's Music Unlimited service.

In another example, if the URL 63 reads as follows: “sonyrecommends://fire_intent/com.sony.bivl.PLAY/?service_id=21424&asset_id=dccbdef284999e 080208f88c068669ca&category_id=0&option_id=0,” which would result in the following functionality to be performed in response to the “sonyrecommends://”scheme name 62, “fire_intent/” handler-directive 64, and the “com.sony.bivl.PLAY/ . . . ” rest of URL 66:

Intent intent = new Intent(“com.sony.bivl.PLAY”);
intent.putExtra(“service_id”, “21424”);
intent.putExtra(“asset_id”,“dccbdef284999e080208f88c068669ca”);
intent.putExtra(“category_id”, “0”);
intent.putExtra(“option_id”, “0”);

For comparison, a typical URL in Microsoft Windows can be: http://www.microsoft.com/index.php, where http:// is the scheme name and universally known protocol. For security reasons, it is generally not advisable for applications to use well known schemes such as http://, https:// etc. Unlike the typical URLs, the URL 60 does not have to rely on universal protocol schemes. For example, the scheme names 62 of the URL 60, e.g., sonybiv:// and sonyrecommends://, each reference a specific application. In addition, the URL 60 is not dependent on dots in the domain name (e.g., www.microsoft.com; www.microsoft.net, www.microsoft.org). Instead, the URL 60 can have a format entirely without dots (e.g., sonybiv://launch_intent), or alternatively, could incorporate one or more dots between the scheme name 62 and handler-directive 64, or the handler-directive 64 and the rest of URL 66.

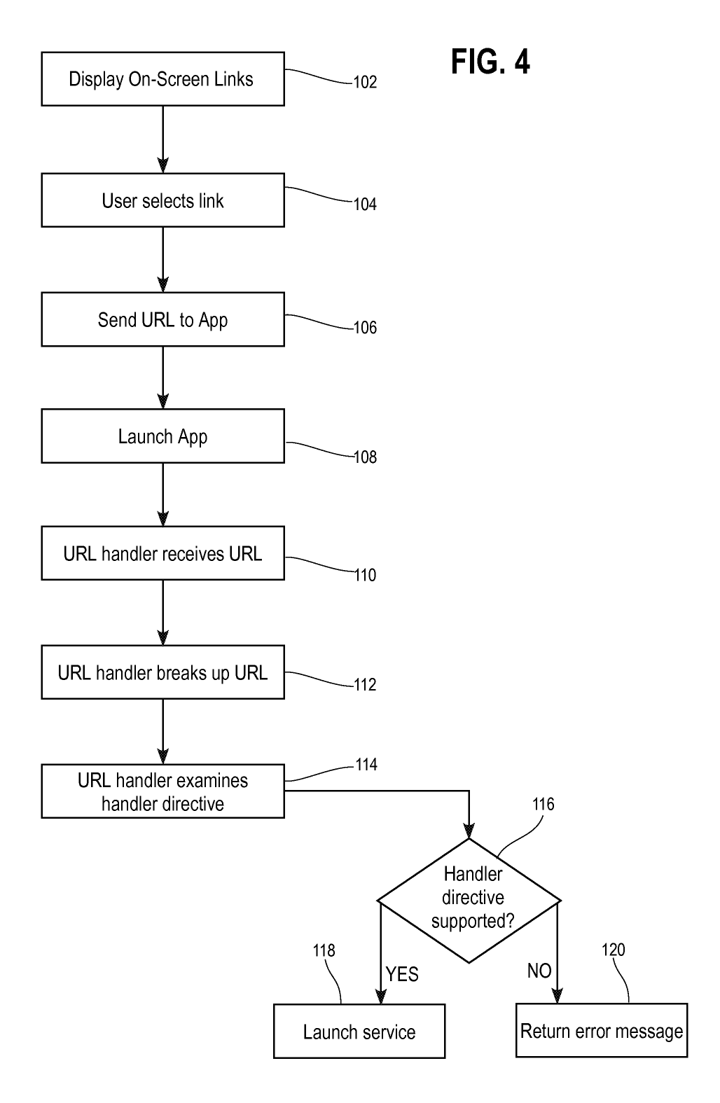

FIG. 4 shows a method of handling Internet links according to one preferred embodiment. With further reference to FIGS. 2-4, in Step 102, a suitable display 10 of an electronic device such as a television, tablet computer, a mobile communication device, or the like, displays one or more on-screen Internet links such as hyperlinks 50, 52, 54, and 56. In Step 104, a user selects, using a mouse, keyboard, remote control, or the like, one or more of the hyperlinks 50, 52, 54, and 56 displayed on the display 10. In Step 106, the URL 60 underlying the selected hyperlink 52 is sent to the referenced resource, the referenced resource being shown by way of example only in FIG. 3 as the Sony Recommends App 70. In step 108, the Sony Recommends App 70 referenced by the URL 60, and more specifically, by the scheme name 62 of the URL 60, is launched. It is to be appreciated that while the Sony Recommends App 70 is shown as being launched in FIG. 3, any functionality or application referenced by the URL 60 that is supportable on an Android or any other suitable Internet TV platform may be launched.

In Step 110, the URL Handler 72 of the Sony Recommends App 70 receives the URL 60, and in Step 112, the URL Handler 72 breaks up the URL 60 to separate at least one of the components of the URL 60. For example, the URL 60 shown in FIG. 3, which includes the scheme name 62, the handler-directive 64, and the rest of URL 66, can be broken to separate only the handler-directive 64 away from the URL 60, or can be broken to separate the scheme name 62 away from the handler-directive 64 and away from the rest of URL 66.

In Step 114 the URL Handler 72 examines the handler-directive 64 of the URL 60 and determines in Step 116 whether the handler directive 64 of the URL 60 is supported in the URL Handler 72. To that end, a list of handler-directives supported in the URL Handler 72 may be specified in the Sony Recommends App 70 or in the URL Handler 72. For example only, the URL Handler 72 of the Sony Recommends App 70, or the URL handler of any other application, service, or functionality that receives a URL including a handler-directive, may be programmed to include a list of handler-directives that would be supported. If it is determined in Step 116 that the handler-directive 64 of the URL 60 is supported, for example, by matching the handler-directive 64 of the URL 60 to one of the handler-directives specified to be supported in the URL handler 72, then in Step 118, the Sony Recommends App 70 would launch the service referenced in the rest of URL 66 portion of the URL 60 as described above. Conversely, if it is determined in Step 116 that the handler-directive 64 of the URL 60 is not supported in the URL handler 72, for example, if the handler-directive 64 of the URL 60 does not match any of the specified handler-directives, then in Step 120, the Sony Recommends App 70 would return an error message to the user.

It is to be appreciated that the above-described methods provide uniform ways of handling URLs across a wide variety of applications, functionalities, and services in an Internet-TV context. Such methods provide improved scalability and result in an increased efficiency for programmers as well as a reduction in cost for Internet-TV and content suppliers.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

What is claimed is:

1. A method of handling Internet links, the method comprising:
providing a link associated with a uniform resource locator (“URL”) in an Internet browser on a display of an electronic device, the link including a scheme name that references an application, and a handler-directive that references a functionality to be performed by the application;
launching the application referenced by the URL in response to a user selecting the URL, the application including a URL handler;
receiving the URL in the URL handler of the application, the URL handler breaking up the URL to separate at least the handler-directive; and
determining whether the handler-directive is supported in the URL handler;
performing, via the application, the functionality referenced by the handler-directive.

2. The method of claim 1, wherein the providing a URL comprises providing a URL including a scheme name comprising a name of the application.

3. The method of claim 1, further comprising returning an error message to the user in response to a determination that the handler-directive is not supported in the URL handler.

4. The method of claim 1, wherein the determining whether the handler-directive is supported in the URL handler further comprises specifying a plurality of handler-directives supported in the URL handler.

5. The method of claim 4, further comprising matching the handler-directive separated from the URL to one of the plurality of handler-directives supported in the URL handler.

6. A method of handling Internet links, the method comprising:
providing at least one link in an Internet browser on a display of an electronic device, the at least one link being associated with a uniform resource locator (“URL”) that includes a scheme name that references an application, and a handler-directive that references a functionality to be performed by the application;
permitting a user to select the at least one link;
launching the application referenced by the URL in response to the user selecting the at least one link;
sending the URL associated with the at least one link to a URL handler of the launched application, the URL including a handler-directive referencing a functionality associated with the launched application;
breaking up the URL in the URL handler to separate the handler-directive; and
determining whether the separated handler-directive is supported in the URL Handler.

7. The method of claim 6, further comprising launching the functionality referenced in the handler-directive via the launched application in response to a determination that the separated handler-directive is supported in the URL handler.

8. The method of claim 6, further comprising returning an error message to the user in response to a determination that the separated handler-directive is not supported in the URL handler.

9. The method of claim 6, wherein the sending the URL includes sending the URL including a scheme name comprising a name of the application.

10. The method of claim 9, wherein the breaking up the URL includes breaking up the URL to separate at least the scheme name and the handler-directive.

11. The method of claim 6, wherein the determining whether the separated handler-directive is supported in the URL handler further comprises storing associating with the URL handler a plurality of handler-directives supportable in the URL handler.

12. The method of claim 11, further comprises determining that the separated handler-directive matches one of the handler-directives supportable in the URL handler.

13. The method of claim 6, wherein the providing at least one link in an Internet browser on a display of an electronic device includes providing an electronic device selected from a group consisting of televisions, personal computers, tablet computers, mobile phones, personal digital assistants, DVD players and video game consoles.

14. The method of claim 6, wherein the permitting the user to select the at least one link includes providing a user with at least one of a keyboard, a mouse, a roller wheel, or a remote control.

15. The method of claim 6, wherein the launching the application referenced by the URL includes launching the application within an Android operating system.
